(19) United States
(12) Patent Application Publication
(10) Pub. No.: US 2021/0390514 A1
(43) Pub. Date: Dec. 16, 2021

(54) AD-HOC TIME ACCOUNTS

(71) Applicant: SAP SE, Walldorf (DE)

(72) Inventors: Ralf Philipp, Altlussheim (DE); Wilko Dann, Ketsch (DE)

(73) Assignee: SAP SE, Walldorf (DE)

(21) Appl. No.: 16/903,134

(22) Filed: Jun. 16, 2020

(51) Int. Cl. G06Q 10/10

(52) U.S. Cl. CPC G06Q 10/1057; G06Q 10/1091

(57) ABSTRACT

Systems, methods, and computer media for implementing ad-hoc time accounts are provided herein. General time accounts can be established for users in a group of users. The general time accounts reflect an amount of leave allocated to the user over a time period, and can be created, for example, as a batch process at the beginning of a time period. A request for an additional leave acquisition can be received for a particular user. An ad-hoc time account can be generated reflecting the additional leave acquisition request. In a time management application, the ad-hoc time account and the general time account can be integrated to reflect a total amount of leave for the user.

### BACKGROUND

Time tracking and management is increasingly accomplished through computer hardware and software. Time accounts are typically used to manage user time, including vacation/leave time, sick time, holiday time, etc., throughout a defined period. Although this time account approach is capable of handling common situations, such as an amount of vacation allotted for a year or accrued in a month, less common user situations can be incompatible with existing time accounts or require manual intervention.

### BRIEF DESCRIPTION OF THE DRAWINGS

FIG. 1 illustrates an example ad-hoc time account method.

FIG. 2 illustrates an example ad-hoc time account method in which general time accounts are established for a group of users and an ad-hoc time account is generated for a user who has requested an additional leave acquisition.

FIG. 3 is a timeline illustrating the example method shown in FIG. 2.

FIG. 4 is a timeline illustrating an example approach for handling multiple additional leave acquisition requests.

FIG. 5 illustrates an example time management system configured to implement some of the described examples.

FIG. 6 illustrates an example ad-hoc time account method in which a publish/subscribe mechanism is used to integrate an ad-hoc time account with a general time account for a user.

FIG. 7 is a diagram illustrating a generalized implementation environment in which some described examples can be implemented.

### DETAILED DESCRIPTION

Time accounts and time management applications are frequently used by organizations and entities to track user or employee work or attendance hours and vacation/leave hours. Typically, time accounts are established or updated for all users in a group on a periodic basis. For example, time accounts for the users can be established or updated to have three, four, five, etc., weeks of leave at the start of a calendar or fiscal year. Similarly, time accounts can be updated at the end of each month to reflect an amount of accrued leave. Such time accounts, however, are typically designed to handle events that occur for all users in a group (e.g., annual leave allotment) and are not well positioned to handle infrequent events or exceptions.

The examples described herein generate ad-hoc time accounts to handle uncommon or less frequently occurring situations that are not anticipated or covered by general time accounts. Examples of such situations include a leave purchase (e.g., a user exchanges salary for additional leave beyond the standard allotment), a holiday reimbursement (e.g., a user receiving additional leave in exchange for working on a holiday), a household move allowance, a medical leave allowance, and a parental leave allowance. Situation-specific rules for validity and/or booking periods can apply to these situations. Ad-hoc time accounts can be integrated with general time accounts in a time management application to provide an accurate representation of a user's total available leave or required attendance time.

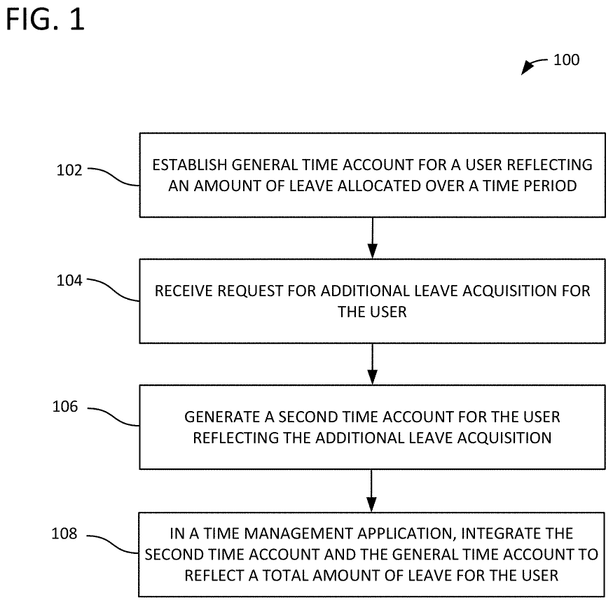

The described examples solve the computer-based problem of how to integrate unexpected, infrequent, or exception-based time data into existing time accounts. Additionally, by creating ad-hoc time accounts on an as-needed basis (rather than for all users at once), storage space is reduced and processing power is conserved and can be allocated to other processes. Ad-hoc time accounts further simplify and clarify the user interface of time management applications by not including information or categories with a balance of “0” that are not relevant to most users and that can cause confusion (e.g., including leave purchase information for all users when only, for example, 5% of users take advantage of leave purchasing is unnecessarily cluttered and confusing, detracting from the user experience). Examples are described below with reference to FIGS. 1-7.

FIG. 1 illustrates a method 100. In process block 102, a general time account is established for a user. The general time account reflects an amount of leave allocated to the user over a time period. General time accounts can be “permanent,” e.g., established at employment and updated each month, year, etc., or can be “recurring,” e.g., established each month, year, etc. As an example, a recurring time account can be established just before or at the start of a year and assigned a balance of leave (e.g., four weeks) or be updated each week, month, quarter, etc., with an amount of leave accrued. General time accounts can be created, for example, as part of a batch process (e.g., created for all users in a user group at the beginning of or just prior to a time period). General time accounts can also be created upon a user joining the group (e.g., upon hiring or gaining membership status).

In process block 104, a request is received for an additional leave acquisition for the user. The request can be received, for example, through a time management application user interface. The request can also be submitted by an administrator on behalf of the user. Additional leave acquisition can be for many different purposes. Examples include a leave purchase, a holiday reimbursement, a household move allowance for a local move, a medical leave allowance, a parental leave allowance, etc.

In process block 106, a second time account is generated for the user reflecting the additional leave acquisition request. The second time account is an ad-hoc time account—it is generated for the specific purpose of accommodating the user's request for the additional leave acquisition. Ad-hoc accounts are not generated for all users as a default but are instead generated as needed. In some examples, ad-hoc accounts are generated after approval of the user's request, either a rules-based automated approval or approval by an administrator or other person with authority.

Ad-hoc time accounts can have a variety of parameters. Examples include a time account type, leave amount/balance, user identifier, validity period, and booking period, among others. The time account type for ad-hoc time accounts can be “ad-hoc” or can be a sub-type that reflects the additional leave acquisition request such as “leave purchase,” “medical leave,” etc. In some examples, both “ad-hoc” and the corresponding sub-type are included as parameters. In some examples, before an ad-hoc account is generated, a data store is accessed to determine if there is an existing ad-hoc account for the user. If there is, then the existing ad-hoc account is modified to reflect the user's request. If there is not an existing account, a new ad-hoc account is generated.

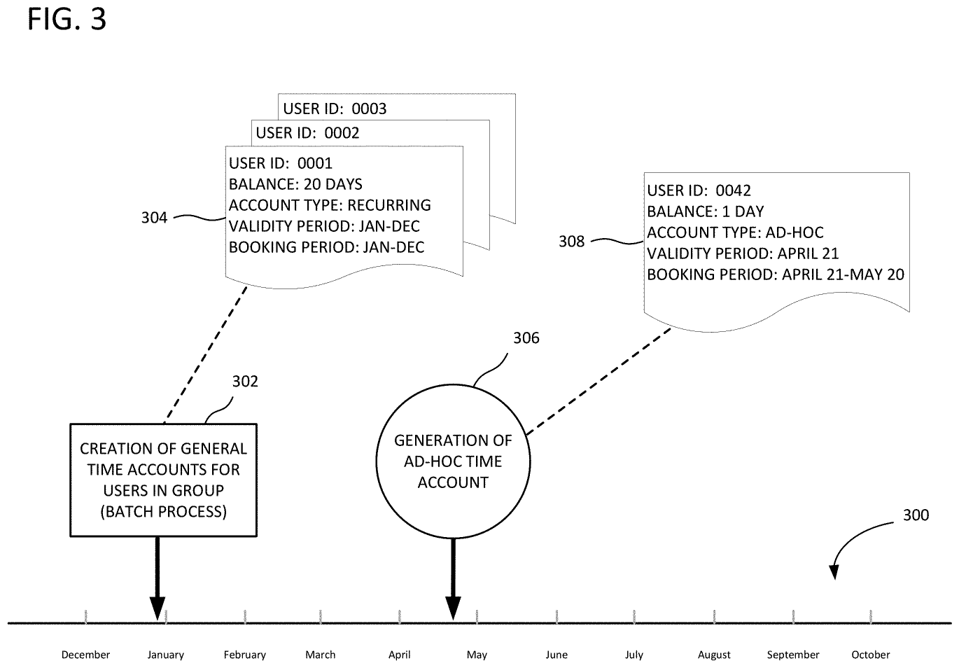

The user identifier can be, for example, an employee or membership ID. Validity period can refer to the time over which leave is valid (e.g., a calendar year, month, etc.). Booking period can refer to the available time period over which leave can be used. In some examples, the validity period for ad-hoc accounts is set for the day the additional leave acquisition is approved, and the booking period reflects the sub-type. In some leave purchase examples, the validity period is set to the day the leave purchase request is approved, and the ad-hoc account is created upon approval. In some such examples, only one time account per time account type for each user identifier is valid at any given point in time. Such a constraint can be established to aid in time account allocation when taking leave, end-of-period (e.g., quarter, year) processing, balance sheet accrual calculations, or other operations. As another example, for a holiday reimbursement in which a user worked on a holiday and is owed an additional day off, a one month booking period can be set as a parameter value. In some examples, validity period and booking period are the same. In other examples, leave can only be used at certain times over, e.g., the course of the year, so although the validity period is a year, the booking period can be different. Example parameters are shown in FIG. 3.

In process block 108, the second time account and the general time account are integrated in a time management application to reflect a total amount of leave for the user. Leave represented in the second time account can have different validity periods and booking periods than leave in the general time account, and this is reflected after integration. The user interface of the time management application can be modified to reflect the total amount of leave for the user, along with corresponding validity/booking dates. For example, an available leave indicator, data visualization, or other user interface element can be updated to reflect the integration of the ad-hoc time account. In some examples, a publish/subscribe mechanism is used in which when an ad-hoc time account is created, an event of event type “ad-hoc time account creation” is identified, and the event is published. A subscriber can subscribe to events of that type such that when an “ad-hoc time account creation” event is published, the subscriber captures the information and provides the ad-hoc time account information for integration with the general time account.

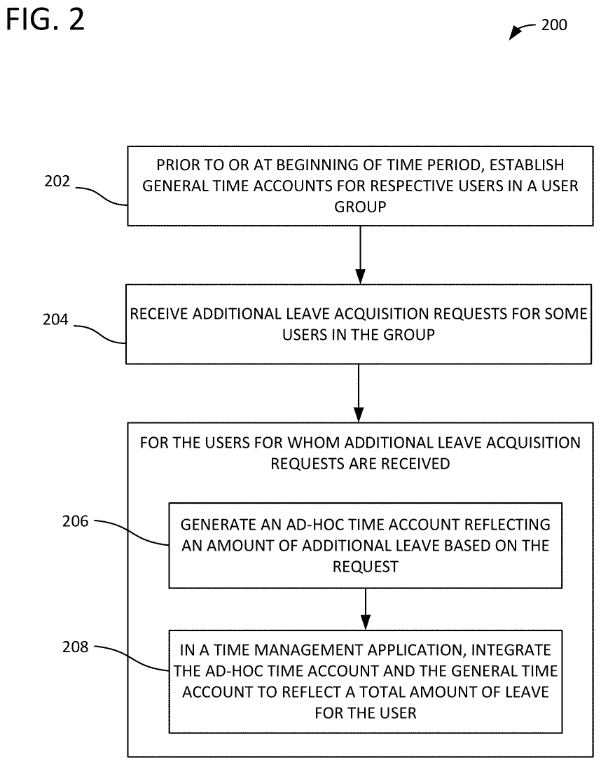

FIG. 2 illustrates a method 200. In process block 202, prior to or at the beginning of a time period, general time accounts are established for respective users in a user group. The general time accounts reflect an amount of leave allocated to the respective users over the time period. This can be done, for example, as a batch process at the beginning of or just prior to a relevant time period (e.g., calendar year, fiscal year, month, etc.). In process block 204, one or more requests for an additional leave acquisition are received for some of the users in the user group. The requests can represent a leave purchase, a holiday reimbursement, a household move allowance for a local move, a medical leave allowance, a parental leave allowance, etc.

Process blocks 206 and 208 are performed for the respective users for whom the requests for an additional leave acquisition are received. In process block 206, an ad-hoc time account is generated reflecting an amount of additional leave granted based on the request. The ad-hoc time account can have multiple parameters including some or all of time account type, leave amount, user identifier, booking date interval, or validity period. In process block 208, the ad-hoc time account and the general time account are integrated in a time management application.

FIG. 3 illustrates an example timeline 300 reflecting generation of general time accounts and an ad-hoc time account. At event 302, general time accounts 304 are generated for all users in a user group as part of a batch process. Event 302 occurs just before January 1^{st}, as shown on timeline 300, and allocates each user the appropriate leave time for the coming year. General time accounts are appropriate for this scenario, because each user is likely entitled to some leave time, even if the amount differs based on employment status, role, tenure, etc. General time accounts 304 show example parameters for the general time accounts, including user ID, balance, account type, validity period, and booking period. As shown in FIG. 3, general accounts are created for multiple (e.g., all) users in the user group.

Event 306 reflects generation of an ad-hoc time account. As shown on timeline 300, generation of the ad-hoc time account occurs in late April and is responsive to a request for additional leave acquisition. For example, a user can request to purchase one day of leave. When the request is approved, an ad-hoc time account 308 is generated reflecting the purchase. Ad-hoc time account 308 shows example account parameters including the user ID (0042), balance (one day), account type (ad-hoc), validity period (April 21^{st}, the day of account creation), and booking period (April 21^{st}-May 20^{th}). In some examples a sub-type, e.g., “leave purchase,” is also included as a parameter or is used as the account type. As illustrated in FIG. 3, computing resources are conserved by waiting until the ad-hoc account was needed to create the account. Similarly, ad-hoc accounts were not created for other users who did not need them.

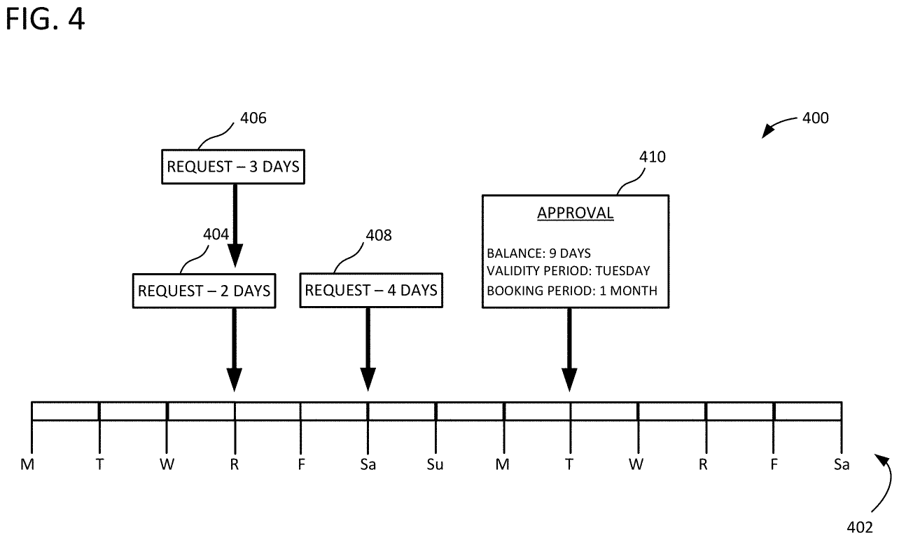

FIG. 4 illustrates a scenario 400 in which multiple requests for additional leave acquisition are received. Scenario 400 includes a timeline 402 spanning a Monday to the Saturday of the following week. Additional leave acquisition requests 404 (for two days) and 406 (for three days) are both received on Thursday. Prior to being approved, additional leave acquisition request 408 (for four days) is received on Saturday. An approval event 410 occurs on the Tuesday following request 408. After the approval, a single ad-hoc time account is created with a balance of nine days (the total of requests 404, 406, and 408). In some examples, three separate ad-hoc time accounts are created for requests 404, 406, and 408. In some examples, only one ad-hoc time account exists per user, and subsequent requests for additional leave acquisitions modify the ad-hoc account.

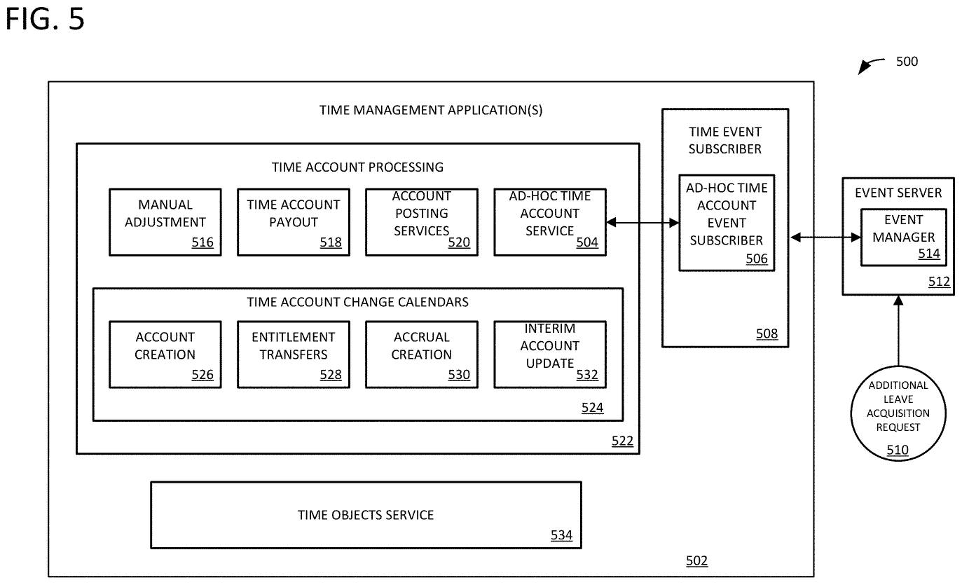

FIG. 5 illustrates an example system 500 capable of implementing the examples described herein, including those illustrated in FIGS. 1-4 and 6. Time management application 502 ad-hoc time account service 504 that receives information regarding newly created or updated ad-hoc time accounts from ad-hoc time account event subscriber 506. Ad-hoc time account event subscriber 506 is contained within time event subscriber 508. Time event subscriber 508 can also subscribe to other event types.

After an additional leave acquisition request 510 is received at event server 512 (e.g., via a user interface of time management application 502 or other application, and in some examples after approval), event manager 514 publishes the generation of an ad-hoc account. Ad-hoc time account event subscriber 506 subscribes to events of that type and receives the payload of the published event, which is communicated to ad-hoc time account service 504 for integration with the general time account. Various other components of time management application 502 are also illustrated, including manual adjustment 516 which allows manual adjustments to time accounts, time account payout 518, which allows monetary redemption of unused leave, and account posting services 520 which can provide information from ad-hoc time account service 504 to the general time account, all of which are part of time account processing 522. Manual adjustment 516 can make additions or deductions to time account balances due to special circumstances (e.g., rounding issues, special agreements, leave awards, etc.) done by an administrator. Time account payout 518 allows conversions of leave into cash during, for example, termination, a special occasion such as hardship, or on a regular basis.

Time account processing 522 also includes time account change calendars 524, including account creation 526, entitlement transfers 528, accrual creation 530, and interim account update 532. Change calendars 524 can be wrappers around batch jobs or certain events, such as creating time accounts or converting accruals into entitlements. Accrual creation 526 creates regular accruals (e.g., daily, monthly, etc.). Interim time account update 532 performs automated large-scale changes (e.g., if leave policy changes for all or a group of users). Time management application 502 also includes time objects service 534. In some examples, event manager 514 is part of time management application 502.

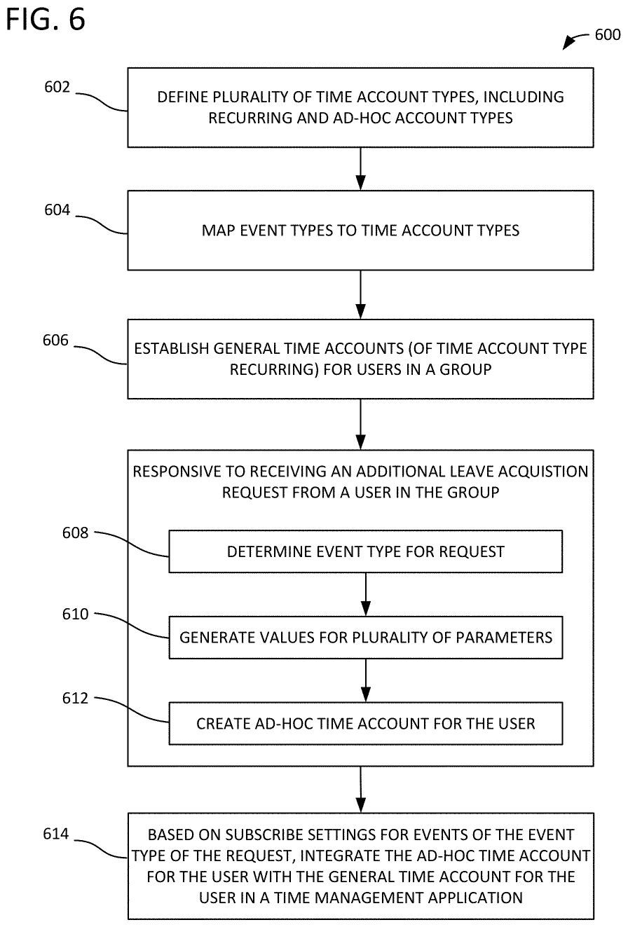

FIG. 6 illustrates a method 600. In process block 602, a plurality of time account types is defined. The plurality of time account types includes a recurring time account type and an ad-hoc time account type. In process block 604 event types are mapped to time account types. For example, a “generate new ad-hoc time account” event type can be mapped to “ad-hoc time account.” A subscriber interested in ad-hoc time accounts can then subscribe to “generate new ad-hoc time account” events and be notified when new ad-hoc time accounts are created.

In process block 606, general time accounts are established for respective users in a user group. The general time accounts can have the recurring time account type and can reflect an amount of allocated leave over a time period. Process blocks 608, 610, and 612 are performed responsive to receiving an additional leave acquisition request from a user in the user group. In process block 608, an event type is determined for the request. In process block 610, values are generated for a plurality of parameters based on the request (e.g., values for user ID, duration, booking period, validity period, etc.). In process block 612, an ad-hoc time account is created for the user based on the values for the plurality of parameters. The ad-hoc time account has the account type of ad-hoc. In process block 614, based on a subscribe setting for events of the event type of the request, the ad-hoc time account for the user is integrated with the general time account for the user in a time management application.

### Example Computing Systems

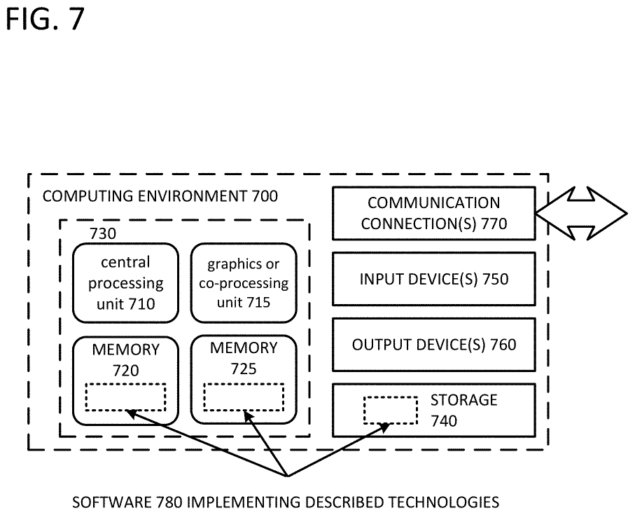

FIG. 7 depicts a generalized example of a suitable computing system 700 in which the described innovations may be implemented. The computing system 700 is not intended to suggest any limitation as to scope of use or functionality, as the innovations may be implemented in diverse general-purpose or special-purpose computing systems.

With reference to FIG. 7, the computing system 700 includes one or more processing units 710, 715 and memory 720, 725. In FIG. 7, this basic configuration 730 is included within a dashed line. The processing units 710, 715 execute computer-executable instructions. A processing unit can be a general-purpose central processing unit (CPU), processor in an application-specific integrated circuit (ASIC), or any other type of processor. In a multi-processing system, multiple processing units execute computer-executable instructions to increase processing power. For example, FIG. 7 shows a central processing unit 710 as well as a graphics processing unit or co-processing unit 715. The tangible memory 720, 725 may be volatile memory (e.g., registers, cache, RAM), non-volatile memory (e.g., ROM, EEPROM, flash memory, etc.), or some combination of the two, accessible by the processing unit(s). The memory 720, 725 stores software 780 implementing one or more innovations described herein, in the form of computer-executable instructions suitable for execution by the processing unit(s). For example, memory 720 and 725 can store ad-hoc time account service 504 and ad-hoc time account event subscriber 506 of FIG. 5.

A computing system may have additional features. For example, the computing system 700 includes storage 740, one or more input devices 750, one or more output devices 760, and one or more communication connections 770. An interconnection mechanism (not shown) such as a bus, controller, or network interconnects the components of the computing system 700. Typically, operating system software (not shown) provides an operating environment for other software executing in the computing system 700, and coordinates activities of the components of the computing system 700.

The tangible storage 740 may be removable or non-removable, and includes magnetic disks, magnetic tapes or cassettes, CD-ROMs, DVDs, or any other medium which can be used to store information and which can be accessed within the computing system 700. The storage 740 stores instructions for the software 780 implementing one or more innovations described herein. For example, storage 740 can store ad-hoc time account service 504 and ad-hoc time account event subscriber 506 of FIG. 5.

The input device(s) 750 may be a touch input device such as a keyboard, mouse, pen, or trackball, a voice input device, a scanning device, or another device that provides input to the computing system 700. For video encoding, the input device(s) 750 may be a camera, video card, TV tuner card, or similar device that accepts video input in analog or digital form, or a CD-ROM or CD-RW that reads video samples into the computing system 700. The output device(s) 760 may be a display, printer, speaker, CD-writer, or another device that provides output from the computing system 700.

The communication connection(s) 770 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed and can include any combination of special-purpose hardware and/or general-purpose hardware with software implementing the functionality described herein.

For the sake of presentation, the detailed description uses terms like “determine” and “use” to describe computer operations in a computing system. These terms are high-level abstractions for operations performed by a computer and should not be confused with acts performed by a human being. The actual computer operations corresponding to these terms vary depending on implementation.

### Example Implementations

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media and executed on a computing device (e.g., any available computing device, including smart phones or other mobile devices that include computing hardware). Computer-readable storage media are any available tangible media that can be accessed within a computing environment (e.g., one or more optical media discs such as DVD or CD, volatile memory components (such as DRAM or SRAM), or nonvolatile memory components (such as flash memory or hard drives)). By way of example and with reference to FIG. 7, computer-readable storage media include memory 720 and 725, and storage 740. The term computer-readable storage media does not include signals and carrier waves. In addition, the term computer-readable storage media does not include communication connections (e.g., 770).

Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present or problems be solved.

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology.

We claim:

1. A method, comprising:
establishing a general time account for a user, the general time account reflecting an amount of leave allocated to the user over a time period;
receiving a request for an additional leave acquisition for the user;
generating a second time account for the user reflecting the additional leave acquisition; and
in a time management application, integrating the second time account and the general time account to reflect a total amount of leave for the user.

2. The method of claim 1, wherein the additional leave acquisition reflects one of a leave purchase, a holiday reimbursement, a household move allowance, a medical leave allowance, or a parental leave allowance.

3. The method of claim 1, wherein the general time account is established as part of a process in which general time accounts are established for a group of users in an organization.

4. The method of claim 1, wherein the second time account is generated on an ad-hoc basis responsive to the request for the additional leave acquisition.

5. The method of claim 1, wherein the second time account comprises a plurality of parameters corresponding to the additional leave acquisition.

6. The method of claim 5, wherein the plurality of parameters represent two or more of: time account type, leave amount, user identifier, booking period, or validity period.

7. The method of claim 1, wherein the second time account is integrated in the time management application through a publish and subscribe mechanism.

8. The method of claim 7, wherein the time management application subscribes to time account generation events having a time account type that matches the time account type of the second time account.

9. The method of claim 1, wherein the request is received through a user interface of the time management application.

10. The method of claim 9, further comprising modifying the user interface of the time management application to reflect the total amount of leave for the user.

11. A system, comprising:
a processor; and
one or more computer-readable storage media storing computer-readable instructions that, when executed by the processor, perform operations comprising:
prior to or at the beginning of a time period, establishing general time accounts for respective users in a user group, the general time accounts reflecting an amount of leave allocated to the user over the time period;
receiving one or more requests for an additional leave acquisition for some of the users in the user group; and
for the respective users for whom the request for an additional leave acquisition is received:
generating an ad-hoc time account reflecting an amount of additional leave granted based on the request; and
in a time management application, integrating the ad-hoc time account and the general time account to reflect a total amount of leave for the user.

12. The system of claim 11, wherein ad-hoc time accounts are not generated for users in the user group for whom requests for additional leave acquisition are not received.

13. The system of claim 11, wherein the additional leave acquisition reflects one of a leave purchase, a holiday reimbursement, a household move allowance, a medical leave allowance, or a parental leave allowance.

14. The system of claim 11, wherein the respective ad-hoc time accounts comprise a plurality of parameters corresponding to the additional leave acquisition.

15. The system of claim 14, wherein the plurality of parameters represents three or more of: time account type, leave amount, user identifier, booking period, or validity period.

16. The system of claim 11, wherein the respective ad-hoc time accounts are integrated in the time management application through a publish and subscribe mechanism.

17. One or more computer-readable storage media storing computer-executable instructions for performing operations, the operations comprising:
defining a plurality of time account types, the plurality of time account types including a recurring time account type and an ad-hoc time account type;
mapping event types to time account types;
establishing general time accounts for respective users in a user group, the general time accounts having the recurring time account type, wherein the respective general time accounts reflect an amount of allocated leave over a time period;
responsive to receiving an additional leave acquisition request from a user in the user group:
determining an event type for the request;
generating values for a plurality of parameters based on the request;
creating an ad-hoc time account for the user, having the ad-hoc time account type, based on the values for the plurality of parameters; and
based on a subscribe setting for events of the event type of the request, integrating the ad-hoc time account for the user with the general time account for the user in a time management application.

18. The one or more computer-readable storage media of claim 17, wherein the operations further comprise, prior to creating the ad-hoc time account for the user, accessing a data store to determine if an ad-hoc time account already exists for the user.

19. The one or more computer-readable storage media of claim 17, wherein the plurality of parameters represents three or more of: time account type, leave amount, user identifier, booking period, or validity period.

20. The one or more computer-readable storage media of claim 17, wherein ad-hoc time accounts are not generated for users in the user group for whom requests for additional leave acquisition are not received.
